(19) United States
(12) Patent Application Publication
(10) Pub. No.: US 2017/0057636 A1
(43) Pub. Date: Mar. 2, 2017

(54) FLYING ROBOT FOR PROCESSING AND CLEANING SMOOTH, CURVED AND MODULAR SURFACES

(71) Applicant: Ridha AZAIZ, London (GB)

(72) Inventor: Ridha Azaiz, London (GB)

(21) Appl. No.: 15/118,849

(22) PCT Filed: Feb. 11, 2015
(86) PCT No.: PCT/DE2015/000057

§ 371 Date: Aug. 12, 2016

(30) Foreign Application Priority Data
Feb. 12, 2014 (DE) 10 2014 001 797.4

(51) Int. Cl. B64C 39/02; F24J 2/46

(52) U.S. Cl. CPC B64C 39/024; F24J 2/461; B64C 2201/108; B64C 2201/12

(57) ABSTRACT

The invention relates to flying robots which can cover large distances between arrangements of smooth or curved surfaces without requiring manual redeployment. This reduces the need for personnel and allows fully-automated maintenance of large surfaces, for example, solar power stations. The flying robot consists of a drive unit having at least two rotors, and is attached to a cleaning module. This comprises a brush, as well as solar cells on one side, and electrodes for receiving current on the other. The flying robot is suitable for use on solar power station, both photovoltaic and photo-reflective. The design of the cleaning module allows the flying robot to charge itself using sunlight or undergo a quick charge using electrodes.

Contaminants on solar panels and on flat or curved mirrors may lead to disproportionate energy losses of a solar power station due to physical effects. It is known to use robots for cleaning glass facades and solar modules. These are heavy and apply high forces to the surfaces. Expensive mechanisms made from suction grippers or wheel drives form actuators and drive the machines.

In dry regions, solar panels are contaminated by dust and sand, which contain quartz and thus have the same raw materials as glass. If such robots function using wheels or suction grippers on the surfaces, then scratches may occur, caused by the material pairing of sand and glass with similar hardnesses, along with high intrinsic weight, slip at wheels, or forces on sealing lips of suction grippers.

Slow movement speeds require long operation at high-energy consumption and also a high number of robots used with respect to the surfaces to be processed or cleaned.

In particular, robots or cleaning devices with wheel drives must be individually adapted in the hardware and software to the size of the solar panels used, as the measurements vary according to module or mirror type and manufacturer.

Wheel drives are, in practice, additionally severely limited in use due to the inclination angle of the solar panels. The module spacing which may be transgressed or driven over is likewise limited by mechanical systems, for which reason only partial automation may be realized.

In order to operate on a different grouping of solar modules, for example, within a larger solar power station, the devices must generally be manually transported due to the large distances between the arrangements of modules, which increases personnel costs.

The underlying problem of the present invention indicated in Claim 1, is to enable smooth, curved, and modular surfaces of, in particular, solar power stations, to be gently freed from contaminants, for example, sand and dust, and to be further processed using a high level of automation.

This problem is solved by the features listed in Claim 1 (a literal citation of the features).

The advantages achieved by using the invention consist in particular in that, due to the high locomotion speeds, the surfaces may be processed faster using a substantially lower number of devices and at a lower energy consumption. By flying, the robots may bridge small and also large distances, which increases the mobility and thus the level of automation.

The cleaning modules and sensors may be actively tracked relative to the drone and parallel to the smooth and curved surfaces, or also equipped with a mechanical locking mechanism. Aside from the cleaning module, no mechanical actuator operates on the surface, since the movement force is generated on the other side.

By using sensors to determine the forces at the cleaning head, in connection with sensors for distance measuring, the distance to the solar module may also be optimized. By using the recording of forces at the cleaning head, established during the cleaning process, the energy required for the method and positioning is minimized with respect to the surface.

If the cleaning head moves against the installed frame, relative to the drone, then the cleaning head may clean itself on the robot, e.g. wipe off a brush. In this way, additional actuators, for, example on the cleaning module, and weight may be saved in favor of, for example, operating duration, since the already present drives may be used for wiping off.

Furthermore, the compact design and low weight enable a high mobility when the robots are used by service personnel at large solar power stations. By using sweeping or wiping motions, which are contingent on movement at a defined distance over the surfaces, the surfaces are freed from dirt.

One advantageous embodiment of the invention is indicated in Claim 2. The refinement according to Claim 2 enables the cleaning module to be set such that the robot is charged in the park position either by sunlight or by a charging station using the electrodes at the supports or on the cleaning module.

The configuration of the electrodes as coils for charging using induction additionally enables a weatherproof configuration of the robot, since these electrodes do not have to be exposed from behind a cover. Additional exposed electrodes on such a cover enable a redundant energy efficient energizing and charging.

Due to the mobility of the robot, in connection with the integrated solar cells of the cleaning head, an optimal orientation may be determined for assuming the sunniest park position.

Due to the limitation to a mechanical adjustment and omitting the frame with supports, additional weight is removed, and the adoption of a landing position may be influenced to the effect that the flying robot is lowered with the solar cells toward the sun.

The possibility of accommodating a smartphone enables control of the flying robot to be integrated in the smartphone, if necessary, under consideration of connectivity. Providing the cleaning module with adapters for additional peripherals supports the separate acquisition of the cleaning modules for, if necessary, peripherals and infrastructure which are present.

One embodiment of the invention is shown in the drawings and is subsequently described in greater detail.

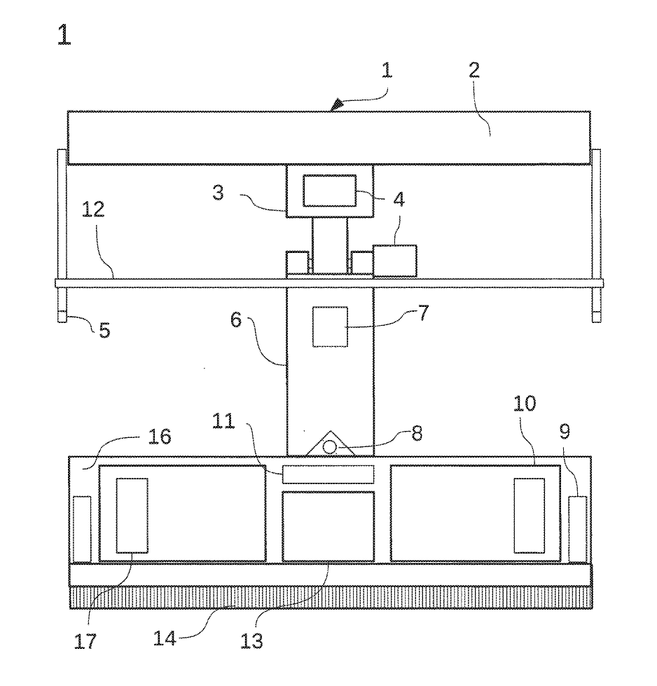

FIG. 1 shows the robot (1) in the view from behind with the cleaning module without adjustment,

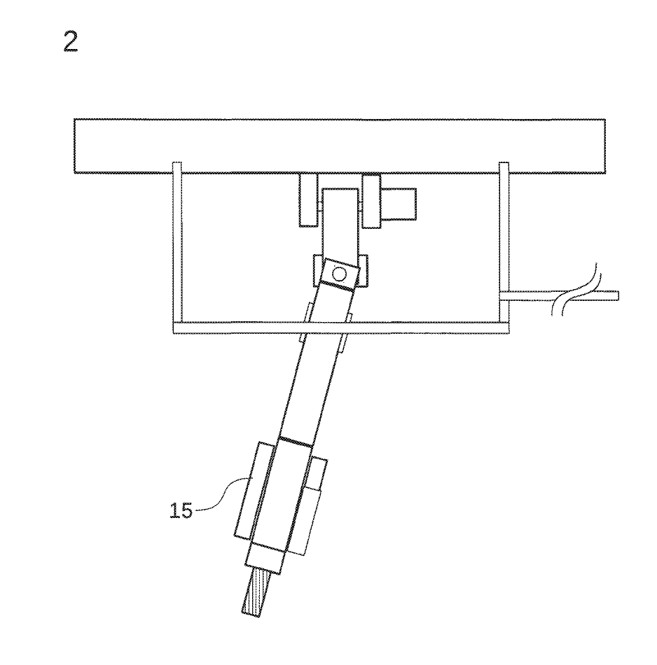

FIG. 2 shows the robot in a view from the side with the cleaning module while adjusted,

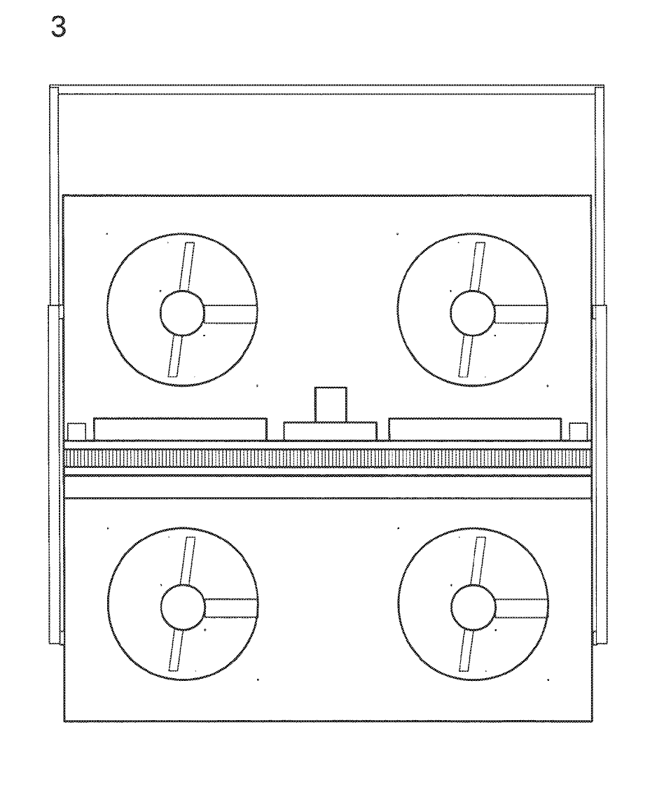

FIG. 3 shows the robot in a view from below with the cleaning module without adjustment.

The flying robot 1 connects a drone 6 via a rotational drive 3 with motors on two axes 4 to a cleaning module 6. Drones are available with two, three, four, five, six, etc. rotors. In this embodiment, a drone with four rotors is selected (FIG. 3).

In the start position, the flying robot with the support frame 12 lies on the ground, wherein the cleaning module is folded horizontally inward via the rotational drive. The backside of the support device 16 is thereby oriented with its exposed electrodes 17 or housed induction coils 10 toward the ground. A mechanical locking mechanism 8 enables the static orientation corresponding to the angle of the surface to be processed. This is indeed likewise possible using the rotational drive; however, this saves energy. Furthermore, the cleaning head may be rotated toward the support frame to wipe off the cleaning head there and, for example, to enable freeing the brush hairs from sand.

The ultrasonic sensors 9 measure the distance to the inclined surface and are, like the receptacle for smartphones 13 and the drone, electrically connected to the control electronics 11. The strain gauge 7 is arranged on the cleaning module such that this records the forces applied, specifically introduced by the attachable cleaning head 14, and is likewise supplied by the control electronics. Cleaning head 14 is attached in this case to the support device as a strip brush. This may, however, also be realized as a sponge.

Large area solar cells 15 are present on the front side of the cleaning module. These are oriented toward the sun in the park position, by which means the batteries of the drone may be optimally charged. By this means, the range of the flying robot is increased overall and commuting, e.g. trips to a charging station, are saved. The longitudinal configuration of the cleaning module additionally reduces wind resistance.

The rotational drives enable the cleaning module to protrude beyond the support frame during operation and to reach the surfaces to be processed.

In addition, these drives support the orientation of the cleaning module prior to assuming the landing position in the preferred orientation, in which the solar panel faces the sun. The combination of the cleaning module with solar cells extends the operating time during the day and enables autonomous and long-term use.

The cleaning of the cleaning head on the support frame further supports the completely autonomous and energy efficient operation, in particular, in large solar power stations. The receptacle for a smartphone supports the connectivity of the flying robot.

The orientation of the induction coils and the electrodes toward the bottom enable landing on an induction plate to subject the flying robot to a quick charge for higher utilization. Drones on the market already have the function of landing at a defined point. If this landing point is equipped with a charging device made of an induction plate, then the robot may be fully automated and autonomously operated. The incorporation of electrodes on support frame 5 thereby provides redundancy and security in case, for example, the electrodes of the support device are not charged due to the assumption of a faulty park position.

The support device may be suitably shaped for different modules, e.g. sun mirrors, by which means even concentric mirrors may be cleaned using the flying robot.

If the drone has the capability, based on variable control of the rotors, to direct the cleaning module completely parallel to the surface to be processed, then the locking mechanism and also the rotary drive may be omitted. The depicted assembly of the cleaning module on the drone then supports the landing in the preferred orientation to align the solar panel toward the sun. In this operating mode, additional weight and components are saved.

1. A flying robot for processing and cleaning smooth, curved, and modular surfaces, in particular, of solar modules, solar reflectors, and glass, characterized in that
the flying robot is made from a flying body with multiple rotors, called a drone, comprising a cleaning module, a locking mechanism, and a drive for translational or rotational positioning and tracking with respect to the surface,
movement forces in any direction and the adoption of static positions are generated by the drone,
a cleaning module is attached to the drone and mechanically receives supporting forces during the cleaning process,
the cleaning module has a mechanical locking mechanism which defines the orientation of the cleaning module to the surface and also influences the position and orientation of the cleaning module during landing,
a cleaning module is adaptable to the curvature of the surface due to differently shaped, exchangeable support devices,
the drone is provided with a frame which cleans a cleaning module during a cleaning operation against the frame,
the cleaning module and the associated retaining frame are provided with adapters for permanent attachment to the drone, for the drive for positioning, for the locking mechanism, the charging station, smartphones, other robots or automats,
a strain gauge records the force applied at the cleaning module,
a separate accumulator additionally energizes the flying robot during a battery exchange or power outage,
the drone generates sufficient lift force on the flying robot, by which means, except for the cleaning module, no actuators tactilely affect the surface,
the cleaning module has an receptacle for a smartphone,
sensors for distance measurement are respectively arranged toward the ends of the cleaning module to enable navigation along the modular surfaces.

2. The flying robot for processing and cleaning smooth, curved, and modular surfaces according to claim 1, characterized in that
the cleaning module can be unfolded by the drive for translational and rotational operation with respect to the drone for starting, and can be supportively folded into the robot for landing,
the cleaning module has solar cells on the back side thereof which face the sunlight in the folded in state,
the cleaning module has electrodes for current supply on the front side thereof, which face the charging station in the folded in state,
the supports of the robot are designed as electrodes,
the electrodes of the cleaning module or of the supports are designed as coils for charging via induction,
wheels, brushes, and sponges on the cleaning module accept forces in order to reduce the lift forces to be generated.
